(19) United States
(12) Patent Application Publication
(10) Pub. No.: US 2013/0011103 A1
(43) Pub. Date: Jan. 10, 2013

(54) OPTOELECTRONIC CONNECTOR HAVING IMPROVED OPTICAL MODULE

(75) Inventors: LE YU, Kunshan (CN); YA-DONG ZHU, Kunshan (CN); YUN-CHENG HOU, New Taipei (TW); JOHN CHOW, Saratoga, CA (US)

(73) Assignee: HON HAI PRECISION INDUSTRY CO., LTD., New Taipei (TW)

(21) Appl. No.: 13/542,608

(22) Filed: Jul. 5, 2012

(30) Foreign Application Priority Data
Jul. 5, 2011 (CN) 201110186192.6

(51) Int. Cl. G02B 6/36

(52) U.S. Cl. 385/90; 385/93

(57) ABSTRACT

An optoelectronic connector includes a cover, a circuit board mounted in the cover, and an optical module assembled to the circuit board. The optical module includes a lens module having a U-shaped receiving space, a ferrule mounted on an end of an optical waveguide, and a locking bolt releasably inserted through the lens module and assembled into the ferrule. The ferrule has two opposite side walls and adapted to be at least partly received within the receiving space. The locking bolt is configured for securely mounting the ferrule and lens module together.

### BACKGROUND OF THE INVENTION

1. Field of the Invention

The present invention relates to an optical module and an optoelectronic connector having the same, and more particularly to an optical module and an optoelectronic connector applied in an optical or optoelectronic device, or optical or optoelectronic integrated circuit, for providing a low loss optical coupling between the optical waveguide and the device or integrated circuit for optical signal transmission.

2. Description of Related Art

U.S. Pat. No. 5,960,141 issued to Sasaki et al. on Sep. 28, 1999 discloses an optical connector having a first ferrule and a second ferrule. The first ferrule is mounted on a board. The second ferrule is assembled to an end of an optical fiber received in a housing. The optical connector has a sleeve for receiving the ferrules together that is configured for optically aligning the ferrules, a latching mechanism assembled to the board and configured for releasably locking the housing along a mating direction, and a coil spring set in the housing for providing a pressure to the second ferrule towards the first ferrule.

U.S. Pat. No. 8,195,017 issued to Kaneshiro et al. on Jun. 5, 2012 discloses an optical transceiver module including an optics system module, a jumper connected a plurality of fibers, and a latch holding the jumper to the optics system module. The latch has a pair of locking arms configured as spring elements. The locking arms have a front portion mating with the optics system module and a rear portion mounted onto the jumper and configured for connecting the jumper and the optics system module together. The jumper has two guiding apertures at a front mating portion that opens towards the optics system module. The optics system module has a pair of protrusions that mate with respective openings formed in the jumper to optically align the optics system module with the jumper.

An optoelectronic connector having an improved optical module is desired.

### SUMMARY OF THE INVENTION

Accordingly, an object of the present invention is to provide an optical module having an improved optical connection with a simple configuration, and an optoelectronic connector having the same.

In order to achieve the object set forth, an optoelectronic connector in accordance with the present invention includes a cover, a circuit board assembled in the cover, and an optical module mounted onto the circuit board. The optical module includes a lens module having a base portion and a pair of guiding walls defining a receiving space therebetween, a ferrule having two opposite side walls and adapted to be at least partly received within the receiving space, and a locking bolt releasably inserted through the lens module and assembled into the ferrule configured for securely mounting the ferrule and lens module together. The ferrule is mounted on an end of an optical waveguide which extending out of the cover. The optical module of the optoelectronic connector has a simple configuration, and the ferrule releasably attached to the lens.

Other objects, advantages and novel features of the invention will become more apparent from the following detailed description when taken in conjunction with the accompanying drawings.

### BRIEF DESCRIPTION OF THE DRAWINGS

FIG. 1 is an assembled perspective view showing an optoelectronic connector in accordance with the present invention;

FIG. 2 is an assembled perspective view showing an optical module mounted on a circuit board in accordance with the present invention;

FIG. 3 is an assembled perspective view showing an optical module as shown in FIG. 2;

FIG. 4 a partially exploded view showing the optical module as shown in FIG. 3;

FIG. 5 is an exploded view showing the optical module as shown in FIG. 3; and

FIG. 6 is an exploded view similar to FIG. 5, taken from another aspect.

### DETAILED DESCRIPTION OF THE PREFERRED EMBODIMENT

Reference will now be made in detail to the preferred embodiment of the present invention.

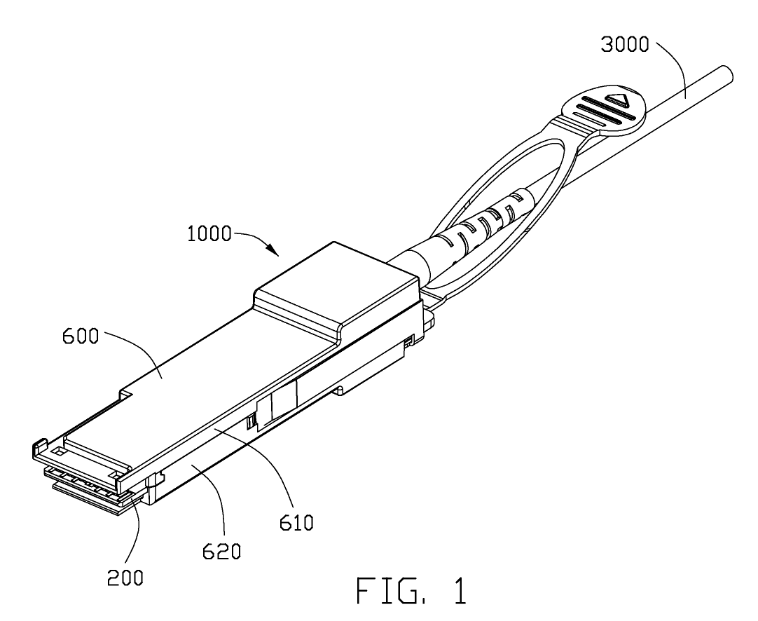

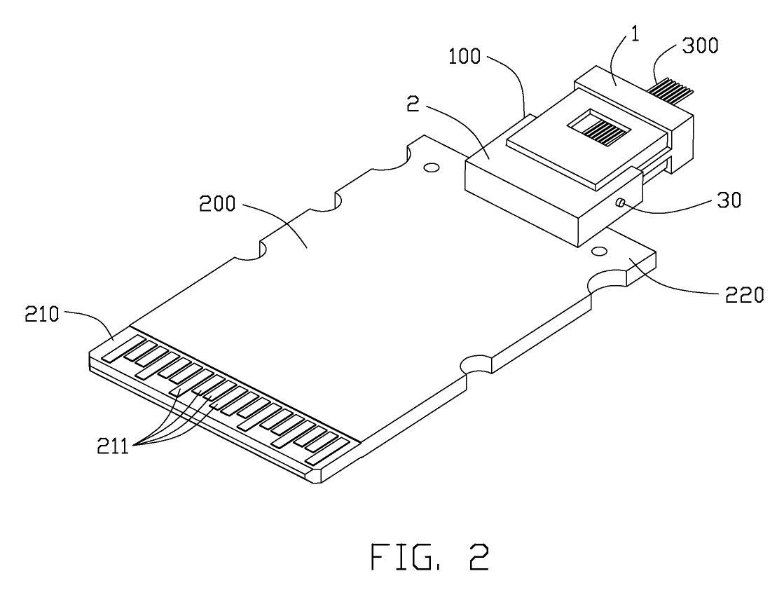

Referring to FIGS. 1 and 2, an optoelectronic connector 1000 in accordance with the present invention is used to connect an optical cable 3000 to a host device, e.g., an optical or optoelectronic device, or optical or optoelectronic integrated circuit, for providing a low loss optical coupling between the optical cable 3000 and the device or integrated circuit. The optoelectronic connector 1000 includes a cover 600, a circuit board 200 assembled in the cover 600, and an optical module 100 mounted onto the circuit board 200.

The cover 600 includes a top cover 610 and a bottom cover 620 assembled to the top cover 610 and defined a cavity therein configured for receiving the circuit board 200. The circuit board 200 has a front mating portion 210 and a rear mounting portion 220. The front mating portion 210 has a number of terminals 211 for transmitting signals between the optical cable 3000 and the host device. The front mating portion 210 partly extends out of the cover 600 for connecting with the host device. The optical module 100 is mounted onto the circuit board 200 adjacent to the rear portion 220. The optical cable 3000 comprises a number of optical waveguides (or optical fibers) 300.

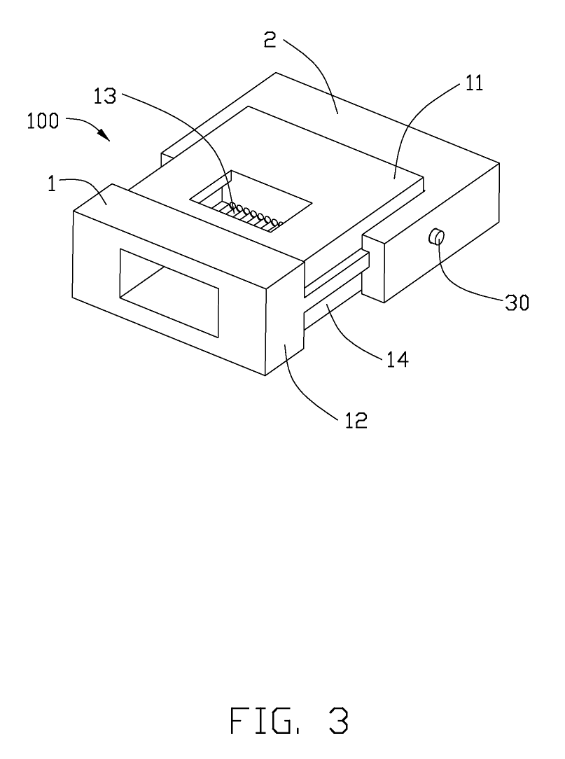

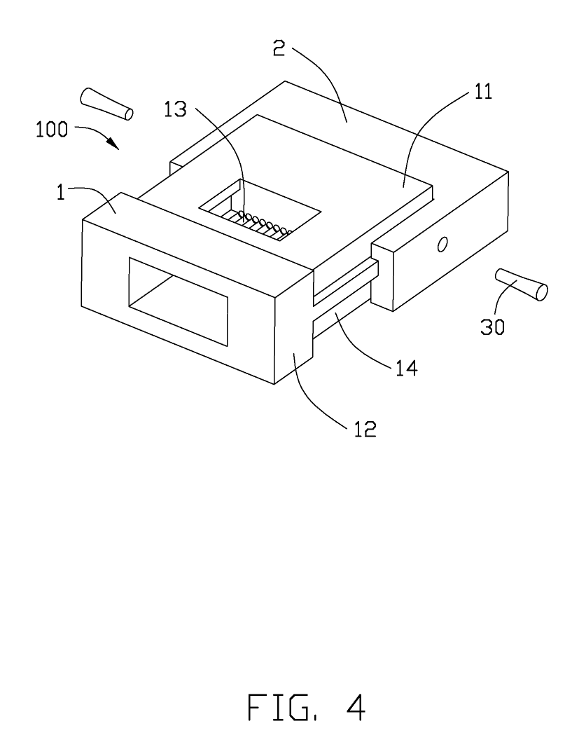

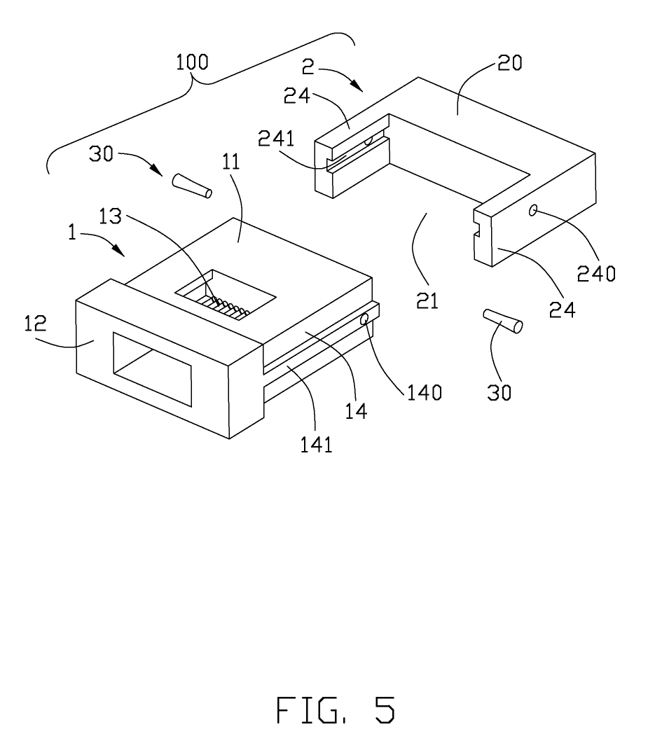

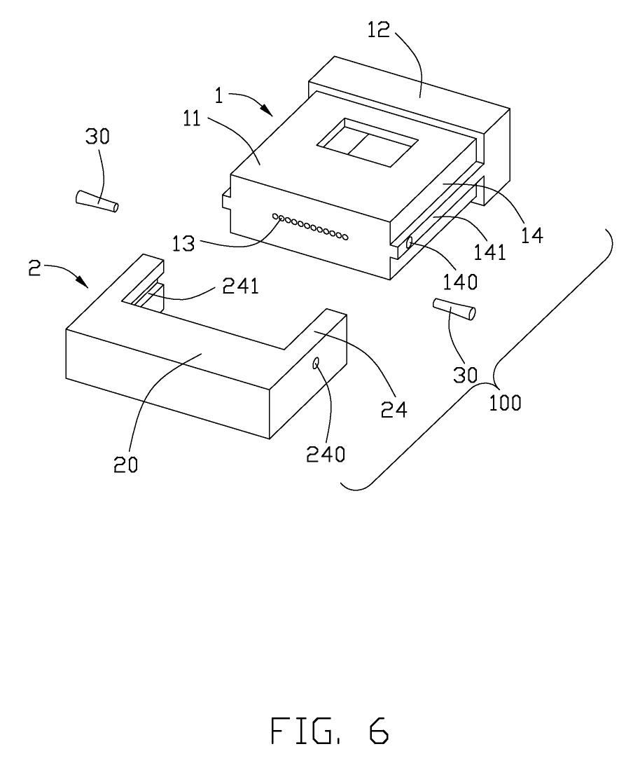

Referring to FIGS. 2-6, the optical module 100 comprises a lens module 2, a ferrule 1 and a pair of locking bolt 30 configured for locking the ferrule 1 to the lens module 2. The ferrule 1 has a front portion 11, a rear portion 12 opposing to the front portion 11, and a plurality of receiving holes 13 extending through the ferrule 1 along a front-to-back direction. The end of the optical waveguide 300 is fixed into the receiving hole 13 and aligned to the lens module 2 with a smooth end surface. The ferrule 1 has two opposite side walls 14. Each of the side walls 14 has a guiding flange 141 protruding and outwardly from the side wall 14, and at least one mounting hole 140 opening vertically to the side wall 14 configured for mounting the locking bolt 30.

The lens module 2 has a base portion 20 and a pair of guiding walls 24 extending backwardly from the base portion 20. The base portion 20 and guiding walls 24 forming a U-shape receiving space 21. Each of the guiding walls 24 has a guiding groove 241 opening towards the receiving space 21. The guiding wall 24 further has a through hole 240 opening along a vertical direction to the guiding wall 24. The through hole 240 is configured for receiving the locking bolt 30. The lens module 2 is mounted onto the circuit board 200 and configured for transmitting optical signals from the optical waveguide 300 to an optical transceiver (not shown) on the circuit board 200, or transmitting optical signals from the optical transceiver to the optical waveguide 300. Usually, the lens module 2 is used for changing the input or output directions of the optical signals.

The guiding flanges 141 are configured for moveably mating with the guiding grooves 241 respectively so as to lead the ferrule 1 optically aligning with the lens module 2. In another embodiment, the guiding flanges 141 could be formed on the guiding walls 24 of the lens module 2. And the guiding grooves 241 could be defined on the ferrule 1.

When the ferrule 1 is completely inserted into the receiving space 21, the thought hole 240 and the mounting hole 140 has a same axis configured for mounting the locking bolt 30. The locking bolts 30 are releasably mounted into the mounting holes 140 for securely locking the ferrule 1 in the lens module 2. Thus, the ferrule 1 could be released from the lens module 2 when the locking bolts 30 are removed from the mounting hole 140. The optical module of the optoelectronic connector has a simple configuration.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An optoelectronic connector comprising:
a cover;
a circuit board assembled in the cover; and
an optical module mounted onto the circuit board, said optical module comprising:
a lens module having a base portion and a pair of guiding walls extending from the base portion, said base portion and the guiding walls defining a receiving space therebetween;
a ferrule mounted to an end of an optical waveguide and adapted to be at least partly received within the receiving space along a mating direction; and
a locking bolt releasably inserted through the guiding wall of the lens module, fixed into the ferrule, and configured for locking the ferrule and the lens module together.

2. The optoelectronic connector as claimed in claim 1, wherein the ferrule has a front portion configured for mating with the base portion of the lens module, a receiving hole extending through the ferrule along a front-to-back direction for mounting the optical waveguide, and two opposite side walls.

3. The optoelectronic connector as claimed in claim 2, wherein each of the guiding walls has a guiding groove opening towards the receiving space, and the side wall of the ferrule has a guiding flange protruding outwardly, the guiding flanges configured for moveably mating with the guiding grooves respectively.

4. The optoelectronic connector as claimed in claim 2, wherein each of the guiding walls has a through hole vertically extending into the guiding wall, and each of the side walls of the ferrule has a mounting hole, the locking bolt adapted to be inserted into the through hole and assembled into the mounting hole.

5. An optical module comprising:
a lens module having a base portion and a pair of guiding walls extending from the base portion, said base portion and the guiding walls defining a receiving space therebetween;
a ferrule mounted to an end of an optical waveguide and adapted to be at least partly received within the receiving space along a mating direction; and
a locking bolt releasably inserted through the guiding wall of the lens module and fixed into the ferrule for locking the ferrule and lens module together.

6. The optical module as claimed in claim 5, wherein the ferrule has a front portion configured for mating with the base portion of the lens module, a receiving hole extending through the ferrule along a front-to-back direction for mounting the optical waveguide, and two opposite side walls.

7. The optical module as claimed in claim 6, wherein each of the guiding walls has a guiding groove opening towards the receiving space, and the side wall of the ferrule has a guiding flange protruding outwardly, the guiding flanges configured for moveably mating with the guiding grooves respectively.

8. The optical module as claimed in claim 6, wherein each of the guiding walls has a through hole vertically extending into the guiding wall, and each of the side walls of the ferrule has a mounting hole, the locking bolt adapted to be inserted into the through hole and assembled into the mounting hole.

9. An optical module assembly comprising:
a printed circuit board;
a lens module mounted to the printed circuit board defining a receiving space therein;
a ferrule mounted to an end of an optical element and adapted to be at least partly received within the receiving space along a front-to-back direction; and
a locking pin releasably inserted through the lens module and the ferrule in a transverse direction perpendicular to said front-to-back direction for locking the ferrule and lens module together.

10. The optical module assembly as claimed in claim 9, further including guiding means respectively formed on both said ferrule and the lens module to assure relative movement between the ferrule and the lens module along said front-to-back direction.

11. The optical module assembly as claimed in claim 10, wherein said lens module defines two opposite side walls on which said guiding means is located.
